(19) United States
(12) Patent Application Publication
(10) Pub. No.: US 2025/0205632 A1
(43) Pub. Date: Jun. 26, 2025

(54) Carbon Dioxide Capture

(71) Applicant: Microsoft Technology Licensing, LLC, Redmond, WA (US)

(72) Inventors: Bharath RAMAKRISHNAN, Bellevue, WA (US); Eric Clarence PETERSON, Woodinville, WA (US); Husam ALISSA, Redmond, WA (US)

(73) Assignee: Microsoft Technology Licensing, LLC, Redmond, WA (US)

(21) Appl. No.: 18/395,239

(22) Filed: Dec. 22, 2023

(51) Int. Cl. B01D 53/04

(52) U.S. Cl. CPC B01D 53/0446; B01D 53/0454; B01D 2253/202; B01D 2257/504; B01D 2258/06; B01D 2259/4009; B01D 2259/404

(57) ABSTRACT

This description relates to removing CO2 from the air. One example includes a duct extending from an external environment to an internal environment and a fan configured to move air through the duct. The example also includes first and second CO2 removal assemblies configured to alternatively transition between CO2 adsorption mode and CO2 desorption mode so that one of either the first and second CO2 removal assemblies is in CO2 adsorption mode and receiving at least some of the air moving through the duct while the other of the first and second CO2 removal assemblies is not receiving air moving through the duct while CO2 is removed in desorption mode.

### BACKGROUND

Large amounts of carbon dioxide (CO2) have been released by human activities; namely burning fossil fuels. These releases have increased the concentration of CO2 in the atmosphere. The increased concentration of CO2 in the atmosphere has increased the percentage of the sun's energy striking earth that is retained rather than radiating back into space. This increased energy retention is warming the planet and causing various negative environmental consequences.

### SUMMARY

This patent relates to removing carbon dioxide (CO2) from the air. One example includes a duct extending from an external environment to an internal environment and a fan configured to move air through the duct. The example also includes first and second CO2 removal assemblies configured to alternatively transition between CO2 adsorption mode and CO2 desorption mode so that one of either the first and second CO2 removal assemblies is in CO2 adsorption mode and receiving at least some of the air moving through the duct while the other of the first and second CO2 removal assemblies is not receiving air moving through the duct while CO2 is removed in desorption mode.

This example is intended to provide a summary of some of the described concepts and is not intended to be inclusive or limiting.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced. Note that some figures illustrate many elements and adding lead lines to all of the elements can diminish readability of the figure. Accordingly, not every element is designated in every figure.

FIGS. 1A and 1B are perspective views that show an example use case scenario with example CO2 removal implementations in accordance with some implementations of the present concepts.

FIGS. 2, 3, 4, 5A, 5B, and 8F show elevational views of example CO2 removal systems and components in accordance with some implementations of the present concepts.

FIGS. 6 and 7 show example schematic diagrams of example implementations of the present CO2 removal concepts.

FIGS. 8A, 8B, 8E, and 9 show perspective views of example CO2 removal components in accordance with some implementations of the present concepts.

FIGS. 8C and 8D show cut-away perspective views of example CO2 removal components in accordance with some implementations of the present concepts.

### DESCRIPTION

The present concepts relate to removing carbon dioxide from air. Various materials are known that can capture CO2 from the air. However, the concentration of CO2 in the air is low (e.g., less than one percent). Thus, air has to be moved over these CO2 capture materials in order for significant amounts of CO2 to be captured and removed from the air. Traditionally this has created an unfortunate conundrum in that energy had to be used to move the air relative to the materials. Yet, a significant portion of available energy is produced by burning fossil fuels. Thus, the act of trying to remove CO2 present in the air because of burning fossil fuels was itself causing fossil fuels to be burned. This reduced the overall efficiency of the traditional CO2 removal processes. The present concepts provide a technical solution to this problem by leveraging air movement that would already occur for other purposes. This leveraging allows the present concepts to offer higher net CO2 removal efficiencies than traditional techniques.

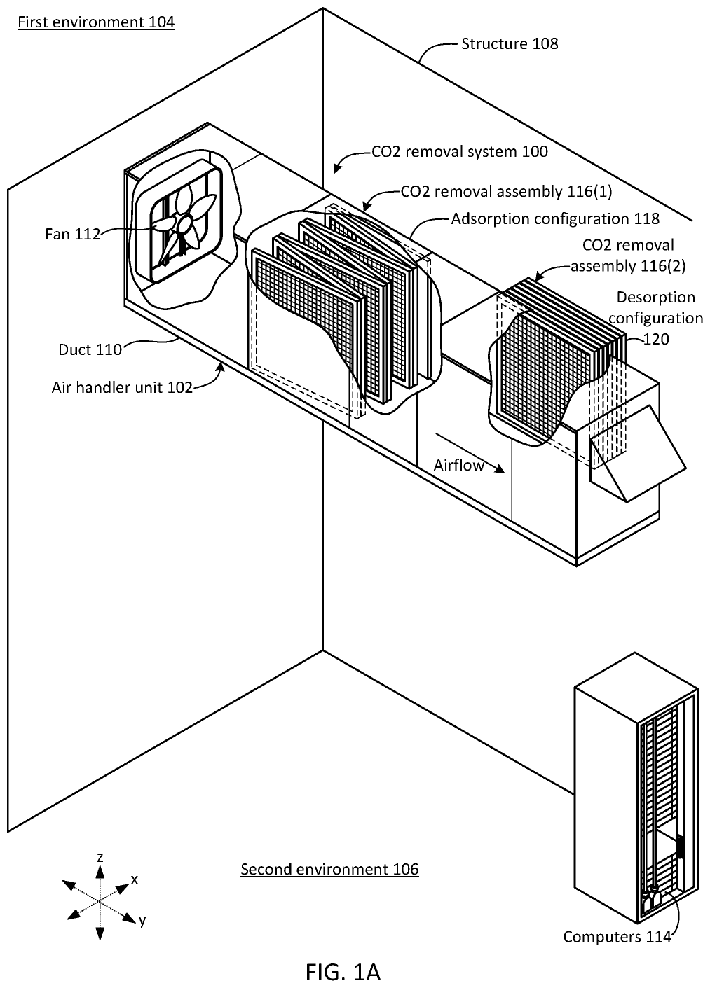

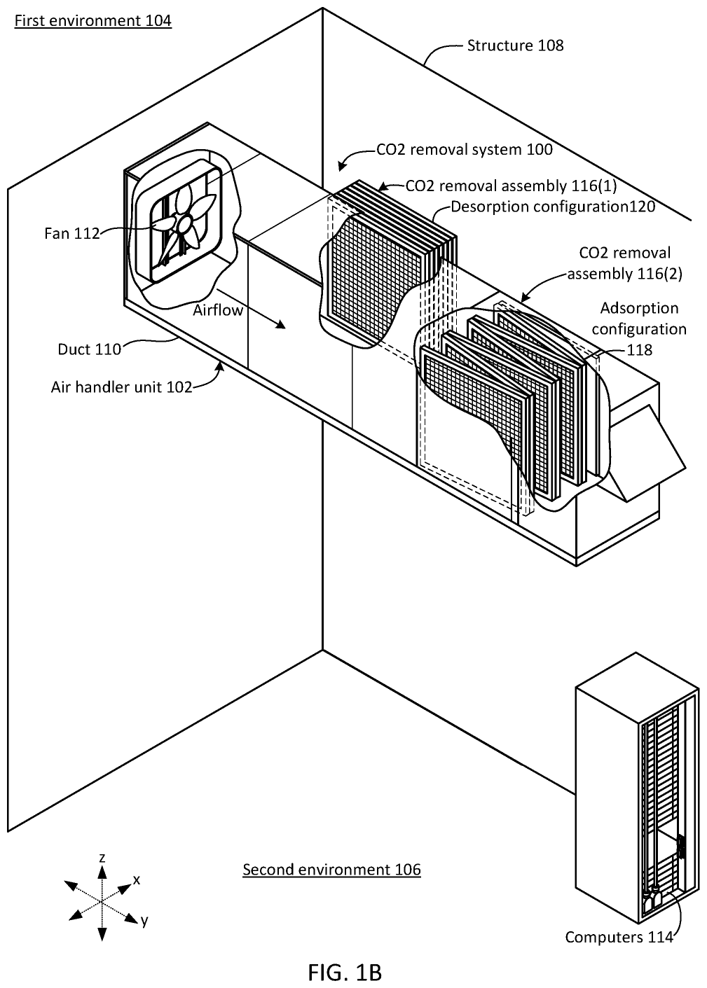

FIGS. 1A and 1B collectively show an example CO2 removal system 100. The CO2 removal system 100 includes an air handler unit 102 configured to move air from a first location or environment 104 to a second location or environment 106. In this example, the first environment 104 is the external environment and the second environment 106 is the inside of a structure 108, such as a building. In this case, the air handler unit 102 includes a duct 110 that extends from the first environment 104 to the second environment 106. In this example the duct 110 extends through the structure 108 (e.g., wall or roof) that separates the first environment 104 (e.g., outside environment) from the second environment 106 (e.g., inside environment). The air handler unit 102 also includes a fan 112 configured to move air through the duct 110 along a long axis which is parallel to the y reference axis.

The air can be moved through the duct 110 for thermal management of the second environment 106 (e.g., the internal environment of the structure 108). For instance, the thermal management can involve heating and/or cooling heat emitting devices, such as computers 114. Alternatively or additionally, the thermal management can involve maintaining a comfortable temperature for users in the internal environment.

Multiple CO2 removal assemblies 116 are positioned relative to the duct 110. This example includes two illustrated CO2 removal assemblies 116(1) and 116(2). The CO2 removal assemblies 116 can transition between an adsorption configuration 118 and a desorption configuration 120. FIG. 1A shows CO2 removal assembly 116(1) in the adsorption configuration 118 and CO2 removal assembly 116(2) in the desorption configuration 120. FIG. 1B shows the CO2 removal assemblies 116 transitioned so that CO2 removal assembly 116(1) is in the desorption configuration 120 and CO2 removal assembly 116(2) is in the adsorption configuration 118.

In the adsorption configuration 118, the CO2 removal assembly 116 receives air moving through the duct 110 and removes CO2 from the air passing in proximity to, and/or through the CO2 removal assembly. In the desorption configuration 120, CO2 transferred from the air to the CO2 removal assembly 116 is subsequently removed from the CO2 removal assembly 116 and captured. The captured CO2 has been removed from the air and can now be handled in an appropriate manner. The CO2 removal assembly 116 has been ‘regenerated’ and is now ready to transition back to the adsorption configuration 118 to begin the process again and remove more CO2 from the air. This implementation illustrates how the present concepts provide a technical solution in that at least one of the multiple CO2 removal assemblies 116 can always be in the adsorption configuration 118 so that airflow through the duct 110 never has to be stopped (because of the CO2 removal assemblies 116) and air never passes through the duct 110 without being filtered (e.g., having CO2 removed) by at least one of the CO2 removal assemblies 116.

Further, this implementation is achieved without the need for expending additional energy to move air relative to the CO2 removal assemblies 116. Instead, the present concepts achieve this CO2 removal by leveraging air movement that was already required for thermal management purposes. Thus, this provides a further technical solution that provides higher net energy efficiency per unit of CO2 removed compared to existing technologies. Existing technologies consume energy to move air over adsorption materials to remove CO2 from the air. The consumed energy increases overall energy consumption. A significant portion of energy production entails burning fossil fuels and thus produces more airborne CO2, thereby decreasing their net efficiency. In contrast, the present implementations can achieve CO2 removal from masses of air that are already being moved for other purposes and therefore can achieve a higher net CO2 removal than traditional techniques.

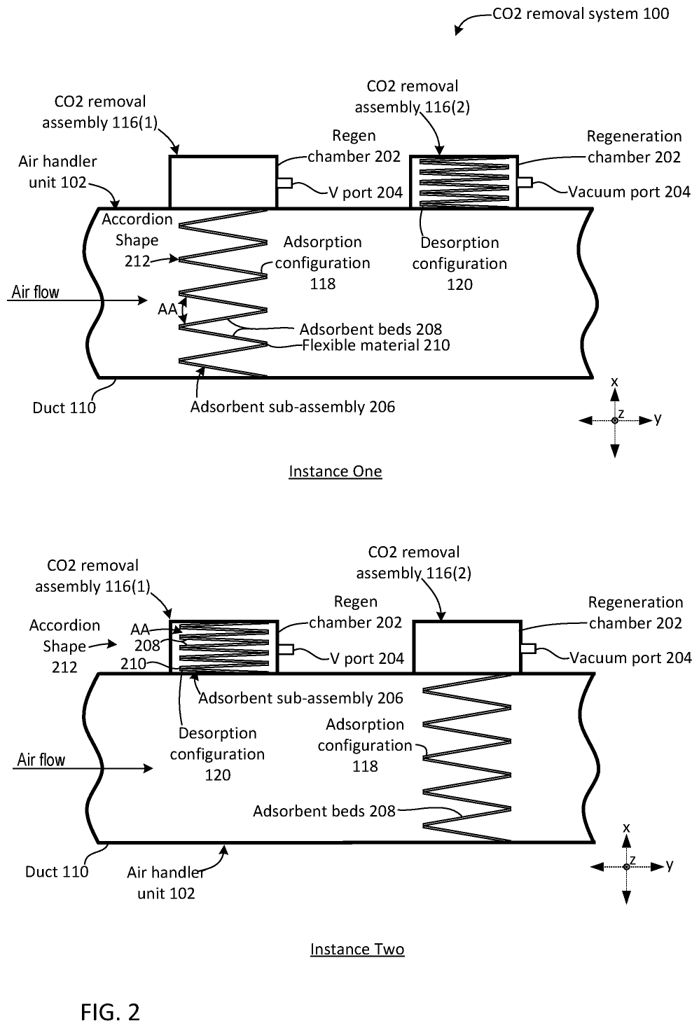

FIG. 2 shows another example CO2 removal system 100. This example shows the CO2 removal assemblies 116 including a regeneration chamber 202. Instance One shows CO2 removal assembly 116(1) in the adsorption configuration 118 and CO2 removal assembly 116(2) in the desorption configuration 120. Instance Two shows CO2 removal assembly 116(1) in the desorption configuration 120 and CO2 removal assembly 116(2) in the adsorption configuration 118. In this case, the duct 110 extends along a long axis (parallel to the y reference axis) and has a width (in the x reference direction) and a height (in the z reference direction) that are measured transverse to the long axis. The width and height constitute a cross section or cross-sectional area of the duct 110. In this case, an individual CO2 removal assembly 116 in the adsorption configuration 118 occupies an entirety of the duct's cross-section.

In this example, the regeneration chamber 202 is positioned outside of the duct 110. In the desorption configuration 120, an individual CO2 removal assembly 116 is positioned in the regeneration chamber 202 and hence is outside of the duct 110. In the regeneration chamber 202, the individual CO2 removal assembly 116 can be subject to various conditions to promote removal of captured CO2 from the CO2 removal assembly 116. For instance, in this example, the regeneration chamber 202 includes a vacuum port 204. Applying a vacuum to the vacuum port 204 can cause CO2 captured by the CO2 removal assembly 116 to be released from the CO2 removal assembly 116 and be evacuated from the regeneration chamber 202.

In this implementation, the CO2 removal assemblies 116 entail adsorbent sub-assemblies 206 that include adsorbent beds 208 and a flexible material 210. In this case, the adsorbent bed includes multiple generally planar portions (e.g., plates or planar-shaped beds) that are interconnected by flexible material 210 in an accordion shape 212. (Adsorbent sub-assemblies 206, adsorbent bed 208, flexible material 210, and accordion shape 212 are labeled only relative to CO2 removal assembly 116(1) to avoid clutter on the drawing page). A CO2 adsorbent material (not visible at the scale of the drawing) is positioned on the adsorbent sub-assemblies 206 including the adsorbent beds 208 and optionally on the flexible material 210. The flexible material 210 couples adjacent adsorbent beds 208 and allows changing a length of the accordion shape 212 in the x reference direction. Other implementations can utilize other configurations. For instance, the flexible material 210 could be replaced with hinges.

In the adsorption configuration 118 the adsorbent beds 208 are oriented at acute angles relative to one another in the duct 110. This allows air to pass through and/or in proximity to adsorbent beds 208 and the flexible material 210 to facilitate CO2 being transferred from the air to the adsorbent. In the desorption configuration 120 the acute angles of the adsorbent beds 208 are reduced as the adsorbent beds 208 and the flexible material 210 are positioned in the regeneration chamber 202. In the regeneration chamber 202 the adsorbent beds 208 are parallel to and against one another or the acute angles are greatly reduced, such as from 20 degrees in adsorption configuration 118 to 2 degrees in the desorption configuration 120, for example. Reducing the angle between the adsorbent beds 208 up to and including being parallel and against one another in the regeneration chamber 202 reduces the volume of the regeneration chamber. This reduced volume facilitates imparting a vacuum on the regeneration chamber to remove CO2 from the adsorbent beds 208.

The adsorbent or adsorbent material can be low temperature (LT) solid adsorbent, such as amines or polyamines, among others. The adsorbent beds 208 can be modularized into small pockets of adsorbent in standard sizes to facilitate adsorbent material handling and service or replacement. For instance, adsorbent beds can be standard sizes that are readily replaceable. Alternatively or additionally, the adsorbent beds can include multiple standard sized adsorbent packets that are readily replaceable as part of the maintenance process.

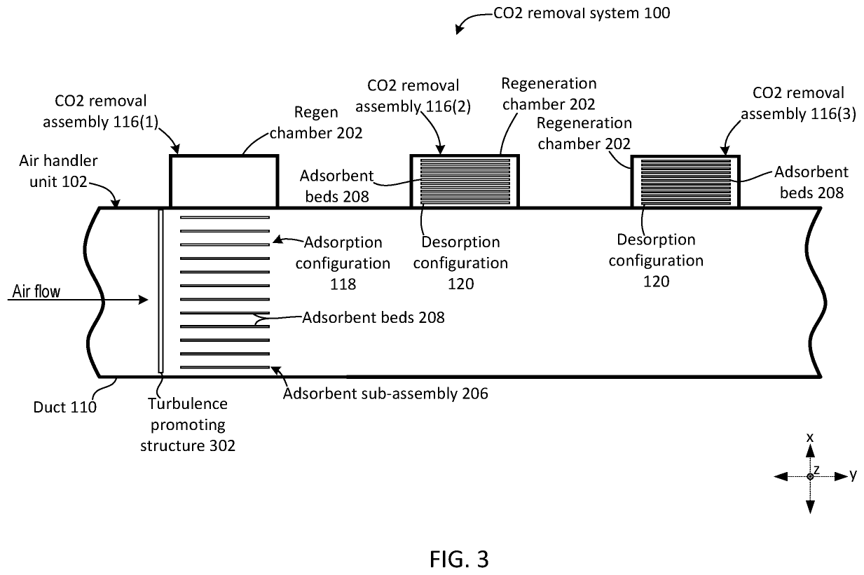

FIG. 3 shows another example CO2 removal system 100 that is similar to the CO2 removal system of FIG. 2 and includes many of the same elements, which are not re-introduced here for sake of brevity. In this case, the adsorbent beds 208 remain parallel to one another in both the adsorption configuration 118 and the desorption configuration 120. In the adsorption configuration 118 the adsorbent beds 208 are spaced relatively farther apart compared to the desorption configuration 120. In the desorption configuration 120, the adsorbent beds 208 are positioned close together and potentially against one another in the regeneration chamber 202. As mentioned above, this facilitates CO2 removal from the adsorbent beds 208 during the regeneration process.

This implementation includes a turbulence promoting structure 302. The turbulence promoting structure 302 promotes turbulent airflow rather than laminar airflow proximate to the CO2 removal assemblies 116. The relatively more turbulent airflow increases interaction between the air and the adsorbent beds 208 and thus increases CO2 removal from the air.

This implementation also includes a third CO2 removal assembly 116(3). The third CO2 removal assembly 116(3) (and additional CO2 removal assemblies) can be utilized in multiple ways. For instance, two CO2 removal assemblies 116 could be in the adsorption configuration 118 while another one is being regenerated in the desorption configuration 120. Filtering CO2 from the air with two consecutive CO2 removal assemblies 116 operating in series on the moving air can remove a higher concentration of CO2 from the air as it moves along the duct 110. Alternatively, the third (or additional) CO2 removal assembly 116(3) could be maintained on ‘stand-by’ status (e.g., regenerated but not capturing CO2). The standby CO2 removal assembly 116 could be employed in various circumstances, such as if the CO2 removal assembly 116 in the adsorption configuration 118 reached capture capacity before the CO2 removal assembly 116 in the desorption configuration was regenerated. Another circumstance could involve failure or maintenance of one of the active CO2 removal assemblies 116(1) and 116(2). In such a circumstance, the standby CO2 removal assembly 116(3) could be brought online to maintain system functionality (e.g., airflow and CO2 removal) while the other CO2 removal assembly 116 was offline.

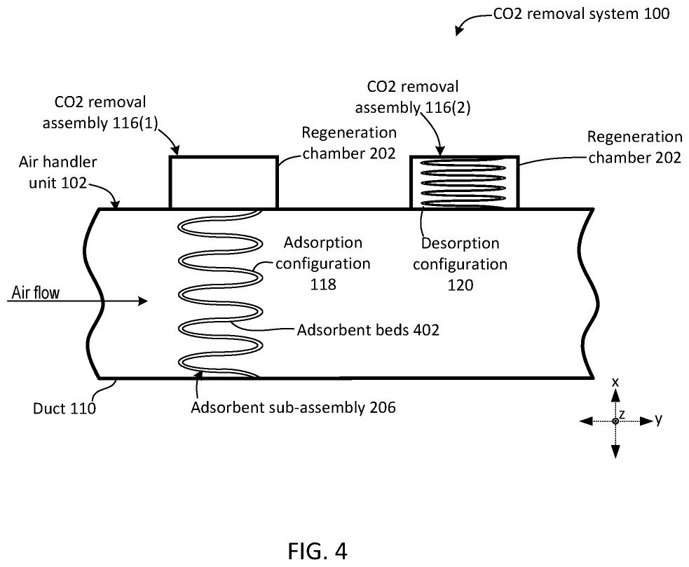

FIG. 4 shows another example CO2 removal system 100 that is similar to the CO2 removal systems of FIGS. 2 and 3 and includes many of the same elements/components, which are not re-introduced here for sake of brevity. In this case, the adsorbent sub-assembly 206 includes a continuous flexible wave-shaped (e.g., sinusoidal) adsorbent bed 402 rather than multiple intercoupled planar adsorbent beds 208 as shown in FIGS. 2 and 3. The length of the continuous wave-shaped adsorbent bed 402 can be extended in the x reference direction (e.g., longer curve) in the adsorption configuration 118 and contracted (e.g., shorter curve) in the desorption configuration 120.

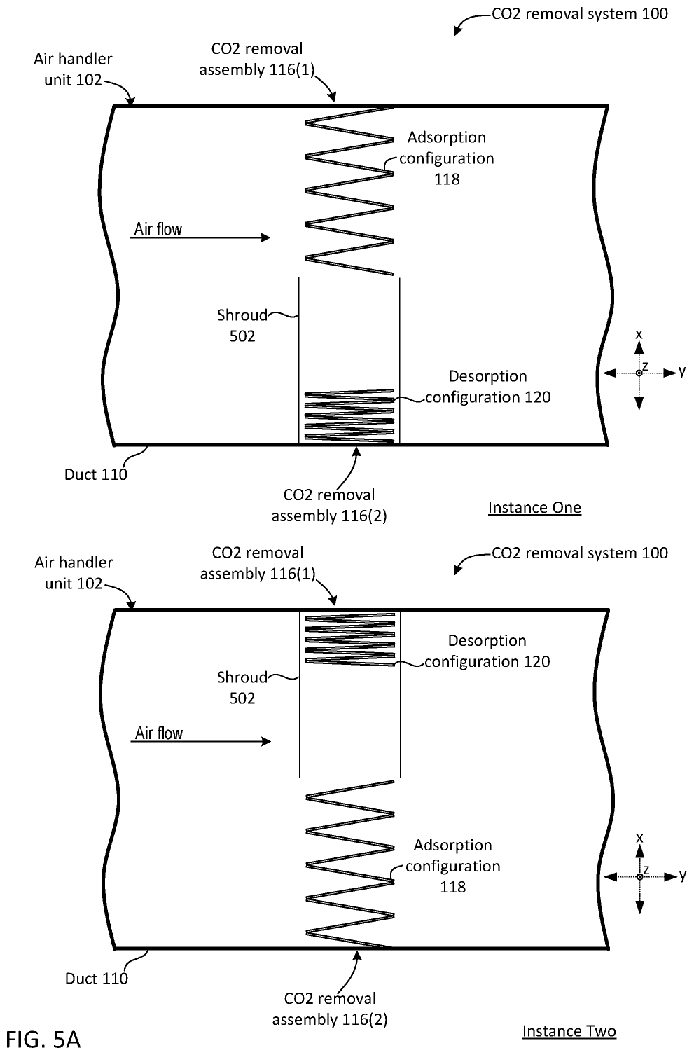

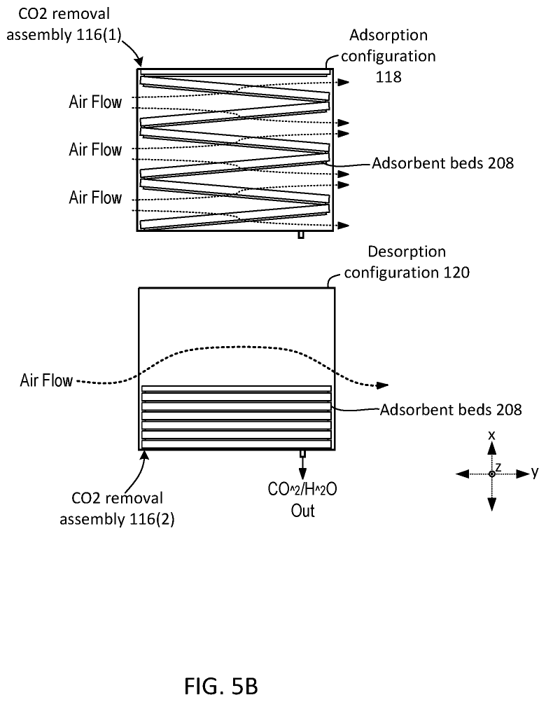

In the implementations illustrated and described relative to FIGS. 1A-4, the CO2 removal assemblies 116 are arranged serially in the duct 110 meaning that the airflow would encounter one CO2 removal assembly 116 before encountering the next CO2 removal assembly 116. Further, in these serial orientations, each CO2 removal assembly 116, when in the adsorption configuration 118 can span the entire cross-section of the duct in the xz plane (e.g., transverse a long axis of the duct, which is parallel to the y reference axis). An alternative configuration is illustrated and described below relative to FIGS. 5A and 5B.

FIGS. 5A and 5B collectively show another example CO2 removal system 100. In this case, multiple CO2 removal assemblies 116 are arranged side-by-side to collectively span the entire cross-section of the duct 110. Individual CO2 removal assemblies 116 can be in different configurations. A moveable shroud 502 blocks air flow from the CO2 removal assembly that is in the desorption configuration 120. Airflow is unimpeded to the CO2 removal assembly that is in adsorption configuration 118. The shroud 502 may also perform functions of the regeneration chamber 202 introduced above relative to FIG. 2.

In Instance One, CO2 removal assembly 116(1) is in the adsorption configuration 118 and CO2 removal assembly 116(2) is in the desorption configuration 120. Moveable shroud 502 blocks air flow from the CO2 removal assembly 116(2) that is in the desorption configuration 120. Airflow is unimpeded to the CO2 removal assembly 116(1) that is in adsorption configuration 118. FIG. 5B shows the relative airflow through the adsorption configuration 118 of CO2 removal assembly 116(1) compared to the desorption configuration 120 of CO2 removal assembly 116(2).

Returning to FIG. 5A, in Instance Two, the moveable shroud 502 has moved in the x reference direction and is now blocking airflow from CO2 removal assembly 116(1), which is now regenerating in the desorption configuration 120. Airflow in the duct 110 can now flow through CO2 removal assembly 116(2), which is in adsorption configuration 118. In the illustrated implementation, the CO2 removal assemblies 116 remain in the duct 110 when they are in the desorption configuration 120. In other implementations, the CO2 removal assemblies 116 in the desorption configuration 120 may move in the x and/or z reference directions outside of the duct 110 to undergo regeneration in a manner similar to FIGS. 1A-4. In the illustrated implementation, two CO2 removal assemblies collectively cover the xz cross-section of the duct 110. Other implementations are contemplated. For instance, four CO2 removal assemblies could be employed with each one covering a quadrant of the xz cross-section of the duct 110. At any given time, at least one CO2 removal assembly would be available to receive air flow and filter CO2 from the air as it passes through the CO2 removal assembly. Further, different types of shrouds 502 are contemplated that can block airflow from a CO2 removal assembly undergoing regeneration in the desorption configuration 120. The shroud can also contribute to the regeneration process, such as by creating an airtight seal around this CO2 removal assembly to facilitate removing CO2 from the CO2 removal assembly via a vacuum applied to the CO2 removal assembly.

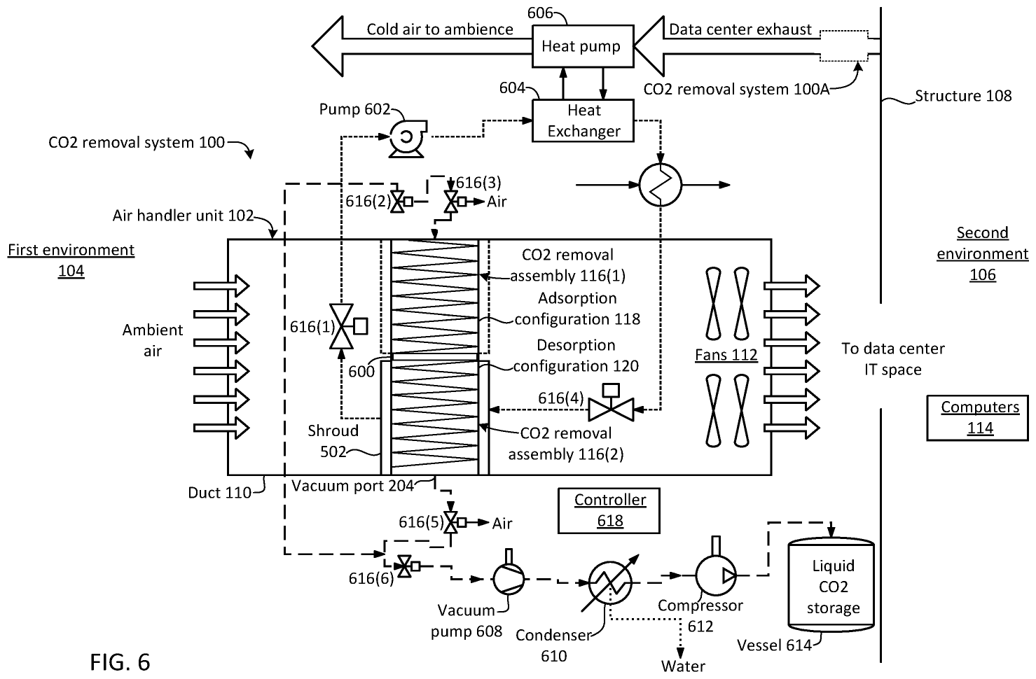

FIG. 6 shows an example operational schematic relating to example CO2 removal system 100. For purposes of explanation, the operational schematic relates to a data center that includes multiple computers 114. The concepts apply to other use cases. This implementation includes air handler unit 102, first environment 104, second environment 106, structure 108, duct 110, fans 112, computers 114, two CO2 removal assemblies 116, vacuum port 204, a plate 600, a pump 602, a heat exchanger 604, a heat pump 606, a vacuum pump 608, a condenser 610, a compressor 612, a vessel 614, multiple solenoid valves 616, and a controller 618.

While not shown on the drawing page to reduce clutter, the controller 618 is in power and/or data communication with the shroud 502, vacuum port 204, pump 602, heat exchanger 604, heat pump 606, vacuum pump 608, condenser 610, compressor 612, vessel 614, and/or the multiple solenoid valves 616, among others. Note also, that to avoid clutter on the drawing page, movement mechanisms, such as motors and linkages are not shown. For instance, the shroud 502 can include a motor and linkage. The motor can be controlled by the controller 618 to change the position of the shroud via the linkage. Similarly, CO2 removal assemblies 116 can include motors that can be controlled by the controller to change the shape of the adsorption beds of the CO2 removal assemblies 116 between adsorption configurations and desorption configurations.

Under a first set of conditions, the adsorbent in the CO2 removal assemblies 116 can adsorb CO2 and under a second set of conditions, the adsorbent in the CO2 removal assemblies 116 can release the adsorbed CO2. At this point, CO2 removal assembly 116(1) is experiencing the first set of conditions in the adsorption configuration 118 and is adsorbing CO2 from ambient air that is moving through the duct 110. Conversely, CO2 removal assembly 116(2) is experiencing the second set of conditions in the desorption configuration 120.

In this example, the second set of conditions include raising the temperature of the second CO2 removal assembly 116(2). This is accomplished with waste heat removed from the computers 114. This heat is captured at heat pump 606 and used to warm a closed loop fluid circuit that includes heat exchanger 604, CO2 removal assembly 116(2) and pump 602. The second set of conditions also involve imparting a (partial) vacuum on CO2 removal assembly 116(2) via vacuum pump 608. Raising the temperature of the adsorbent in the CO2 removal assembly 116(2) in the presence of the vacuum causes the CO2 to be released from the adsorbent material and the CO2 to travel through the vacuum pump 608 to the condenser 610. The condenser 610 cools the partial vacuum stream including the CO2. Any water can then be separated from the CO2. The purified CO2 stream is directed to the compressor 612 which transitions the CO2 from a gaseous state to a liquid state. The liquid CO2 is stored in the vessel 614 awaiting permanent disposal. When the adsorbent of CO2 removal assembly 116(2) is regenerated, the process can switch to the first CO2 removal assembly 116(1) (e.g., the first CO2 removal assembly 116(1) is subject to the second set of conditions and the second CO2 removal assembly 116(2) is subjected to the first set of conditions).

In general operation CO2 adsorption is achieved by flowing ambient air (420 ppm CO2) over the CO2 removal assembly 116(1) that is in the adsorption configuration 118. CO2 removal assembly 116(2) is isolated by the shroud 502 and/or plate 600 to facilitate desorption. Remaining CO2 removal assembly 116(1) will remain on the adsorption mode. Vacuum pump 608 pulls a vacuum on the isolated adsorbent bed of CO2 removal assembly 116(2) to remove air. CO2 release from CO2 removal assembly 116(2) can be controlled with the vacuum level. When regeneration is complete, the shroud 502 can move to allow airflow through the regenerated CO2 removal assembly 116(2) that is now ready for the adsorption configuration 118.

In the illustrated configuration, CO2 removal assembly 116(2) can be sealed tightly before desorption cycle with the shroud 502 and the plate 600. The shroud 502 and the plate 600 can constitute and/or provide a similar function to the regeneration chamber 202 introduced above relative to FIG. 2. Vacuum pump 608 can be used to draw pressure (e.g., vacuum). The vacuum pressure value determines the quality of captured CO2 from the regenerating CO2 removal assembly 116. The higher the vacuum pressure (e.g., lower total pressure), the higher the quality of captured CO2. The heat energy utilized for this desorption process step can be captured from the data center waste heat exhaust using heat pump 606 and heat exchanger 604. Once the desorption step is completed, the released CO2 from the adsorbent bed is pumped out. Condenser 610 can be used to condense and separate water and CO2 molecules. The CO2 vapors can be compressed into the liquid form by the compressor 612 and can be stored in vessel 614 and/or other storage containers for transportation for example. The water can then be reused within the datacenter. The regenerated adsorbent of CO2 removal assembly 116(2) can be cooled to lower temperature conditions, say 45 degrees C., by circulating coolants with pump 602 before starting with the adsorption configuration 118 again to continue regenerative adsorption/desorption cycle of adsorbents.

Note that for purposes of explanation, CO2 removal system 100 is positioned relative to the intake air that is going into the structure 108. Alternatively or additionally, the CO2 removal system 100 could be positioned on the airflow out of the structure 108. This is represented by CO2 removal system 100A positioned on the data center exhaust. CO2 removal system 100A can function as described relative to CO2 removal system 100 except that it would be flipped 180 degrees horizontally to receive air on the right and eject air on the left rather than receiving air on the left and ejecting the air on the right as is shown for CO2 removal system 100.

Recall that as mentioned earlier, one of the technical advantages of the present concepts is that the present implementations can leverage existing air movement rather than requiring additional energy to be spent to move air. Similarly, the second set of conditions can leverage waste heat from the computers or other heat generating electronic components to heat the CO2 removal assembly 116 to facilitate regeneration of the adsorbent.

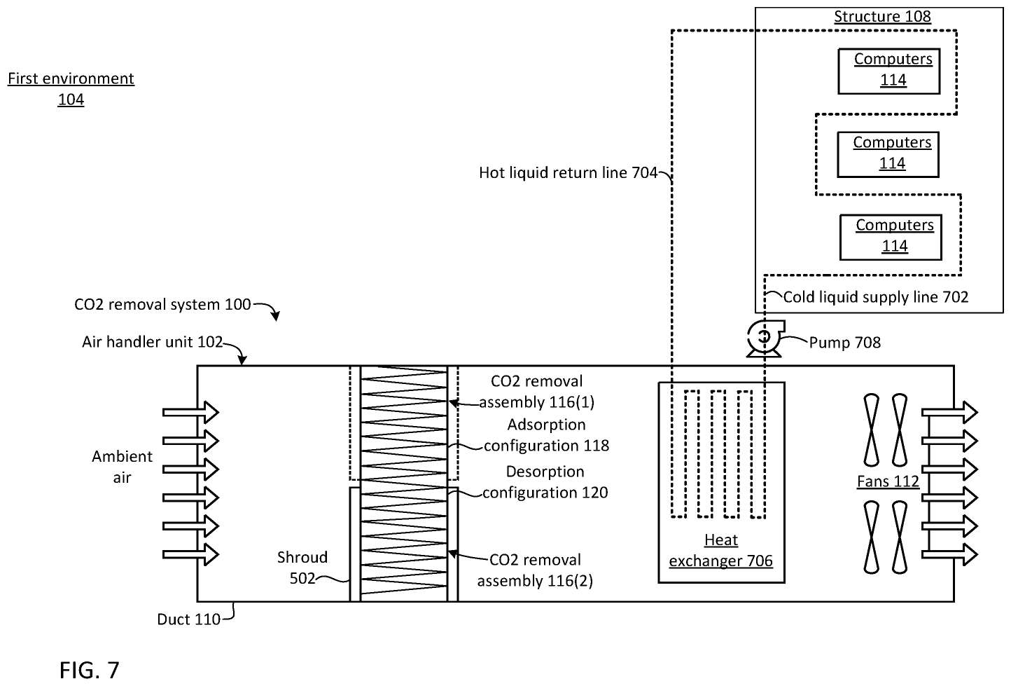

FIG. 7 shows an example operational schematic relating to another example CO2 removal system 100. This implementation involves removing CO2 from moving air in the external or outside environment. This implementation includes a structure 108 that houses heat generating components in the form of computers 114. A liquid cooling system is employed to cool the computers 114. The liquid cooling system includes a cold liquid supply line 702, a hot liquid return line 704, a heat exchanger 706, and a pump 708. Note that the terms ‘cold liquid supply line’ and ‘hot liquid return line’ are used for purposes of explanation, but this is somewhat a matter of semantics in that it is essentially different portions of a single line. Note also that this system works with any suitable liquid coolant, such as water, alcohol, etc. Further, this system works with both single phase (e.g., liquid) coolant and two phase (e.g., liquid phase in the cold liquid supply line 702 and liquid/vapor phase coolant in the hot liquid return line 704).

In operation, cold liquid coolant (e.g., relatively cooler liquid) is forced by pump 708 through cold liquid supply line into structure 108 and past computers 114. The cold liquid coolant picks up heat from the computers 114 and leaves the structure via the hot liquid return line 704. The hot liquid return line enters the heat exchanger 706 where heat from the liquid coolant is transferred to ambient air moved by fans 112 over the heat exchanger 706. CO2 can be removed from this moving air by multiple cooperatively operating CO2 removal assemblies 116 consistent with the explanations above relative to FIGS. 1A-6. Thus, the ambient air starts in the first environment 104 (e.g., as outside air with relatively high concentrations of CO2) and returns to the first environment as warmer ambient air with relatively lower concentrations of CO2. No additional energy was expended moving air for purposes of removing CO2 because the air was already being moved to remove heat energy away from the heat exchanger 706.

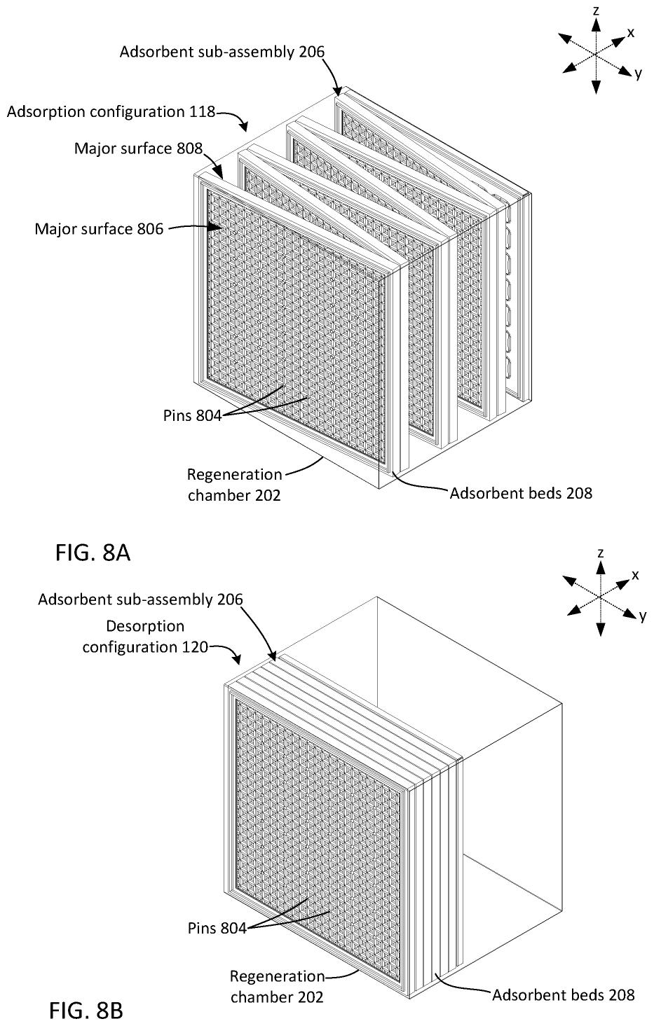

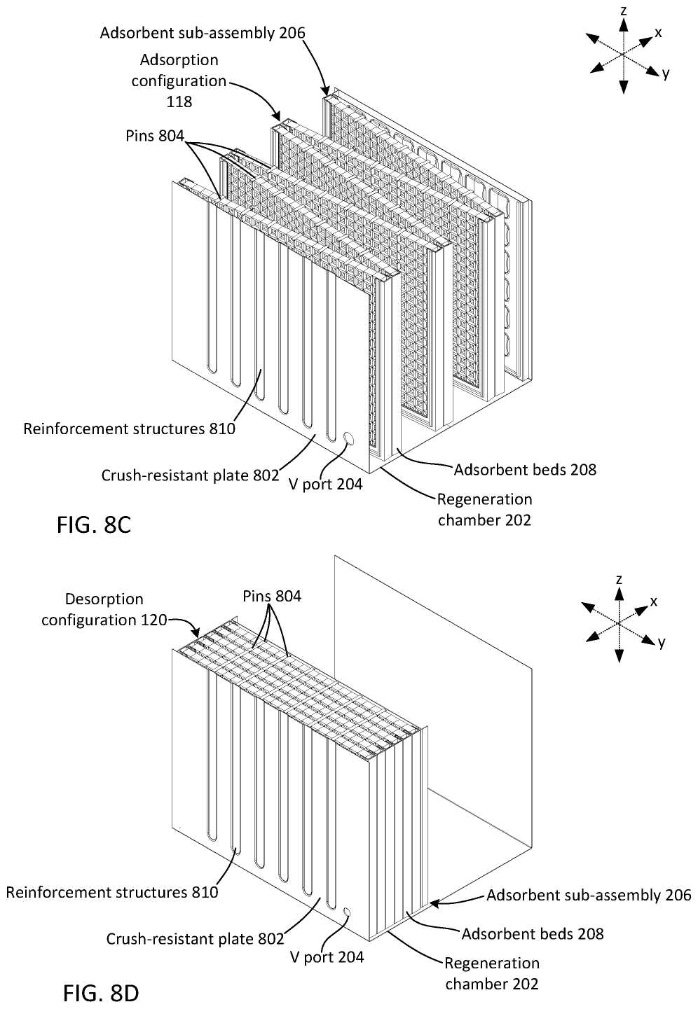

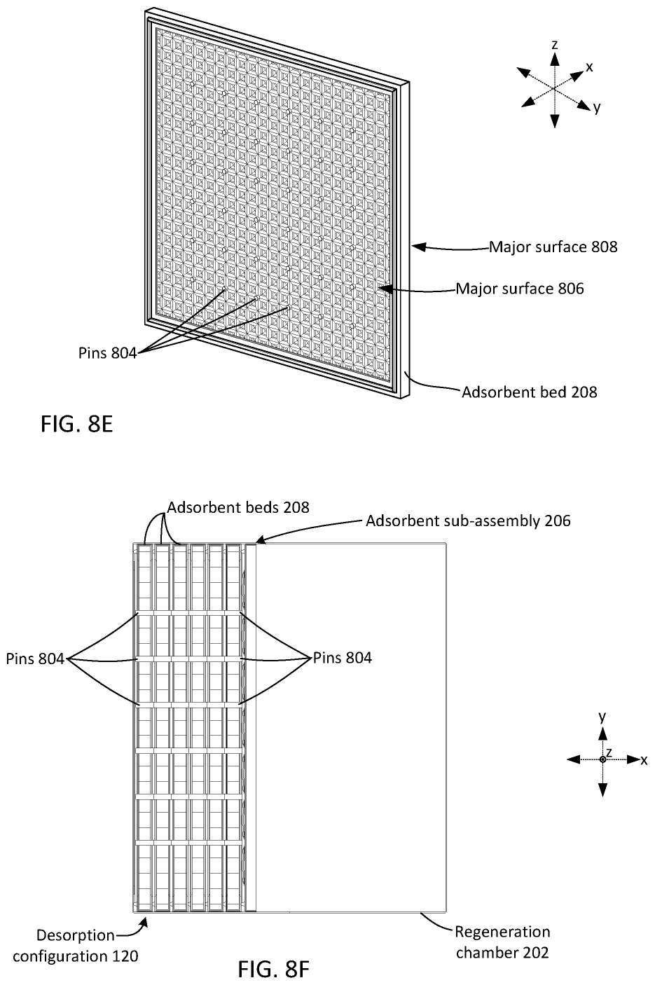

FIGS. 8A-8F collectively show example regeneration chamber 202 and adsorbent sub-assembly 206. This implementation includes a crush-resistant plate 802 on the regeneration chamber 202. In this implementation the vacuum port 204 is defined in the crush-resistant plate 802. Other implementations can position the vacuum port on other areas of the regeneration chamber. This implementation also includes pins 804 in the adsorbent beds 208. FIGS. 8A and 8C show the adsorbent sub-assembly 206 in the adsorption configuration 118. FIG. 8A is a perspective view with the crush-resistant plate 802 removed to visualize the underlying adsorbent beds 208 of the adsorbent sub-assembly 206. FIG. 8C is a sectioned perspective that is sectioned along the xy reference plane to pass through a row of the pins 804. FIGS. 8B, 8D, and 8F show the adsorbent sub-assembly 206 in the desorption configuration 120 with the adsorbent beds 208 positioned generally parallel and against one another. FIG. 8B is a perspective view with the crush-resistant plate 802 removed. FIG. 8D is a cutaway perspective view sectioned along the xy reference plane to pass through a row of the pins 804. FIG. 8F is a sectional view that is similar to the cutaway perspective view of FIG. 8D. FIG. 8E shows an individual adsorbent bed 208 in isolation.

Recall that a vacuum can be applied to the regeneration chamber 202, such as via the vacuum port 204 to remove CO2 from the adsorbent sub-assembly 206. However, applying a vacuum to the regeneration chamber 202 can cause the adsorption beds 208 to be forced against one another with enough force to damage them. This implementation provides a technical solution that eliminates this problem. The technical solution involves the multiple pins 804, such as metal pins that extend between spaced-apart major surfaces 806 and 808 of the adsorption beds 208. The major surfaces are generally parallel to the yz reference plane in the desorption configuration 120. The pins 804 extend parallel to the x reference direction between the major surfaces 806 and 808. In the illustrated implementation, the pins 804 are arranged in a 6 by 6 array. Other configurations are contemplated. Regardless of the configuration of the pins 804, the pins are aligned in each of the adsorbent beds 208. In this configuration, as the adsorbent beds 208 are forced together, the pins 804 of adjacent adsorbent beds contact one another. The pins 804 are crush-resistant and maintain the integrity of the adsorbent beds 208 while they are exposed to the vacuum.

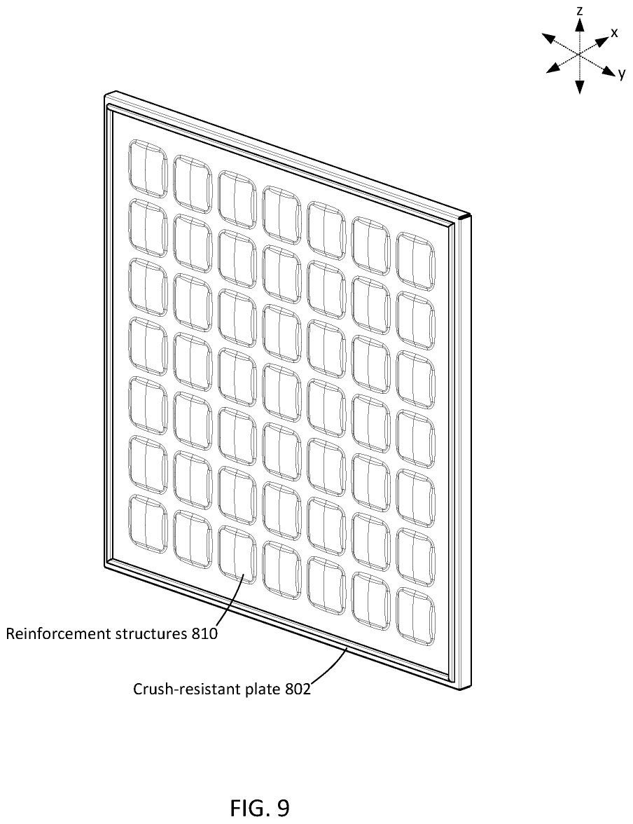

The pins 804 can also align with reinforcement structures 810 on the crush-resistant plate 802. The reinforcement structures 810 reduce/eliminate distortion of the crush-resistant plate 802 when the regeneration chamber 202 is exposed to the vacuum forces. In this implementation, the reinforcement structures 810 are elongate ribs. FIG. 9 shows an alternative configuration where the reinforcement structures 810 are manifest as an array of dimples. Other types of reinforcement structures 810 are contemplated. The two illustrated types of reinforcement structures 810 can be readily fabricated at relatively low cost. For instance, a planar sheet of metal stock can be pressed to form the reinforcement structures 810.

Various example implementations are described above. Additional examples are described below. One example includes a system comprising a duct extending from a first environment to a second environment, a fan configured to move air through the duct, a first CO2 removal assembly having a CO2 adsorption configuration and a CO2 desorption configuration, a second CO2 removal assembly having a CO2 adsorption configuration and a CO2 desorption configuration, and a controller configured to operate the first CO2 removal assembly in the adsorption configuration to receive at least some of the air moving through the duct and the second CO2 removal assembly in the desorption configuration that does not receive air moving through the duct while CO2 is removed and then to operate the first CO2 removal assembly in the desorption configuration that does not receive air moving through the duct while CO2 is removed and the second CO2 removal assembly in the adsorption configuration to receive at least some of the air moving through the duct.

Another example can include any of the above and/or below examples where the air flows along a long axis of the duct and the duct has a cross-sectional area measured transverse to the long axis, and wherein in the CO2 adsorption configuration the first CO2 removal assembly covers all of the cross-sectional area, and wherein in the CO2 adsorption configuration the second CO2 removal assembly covers all of the cross-sectional area.

Another example can include any of the above and/or below examples where the first CO2 removal assembly and the second CO2 removal assembly are positioned in series along the long axis.

Another example can include any of the above and/or below examples where in the desorption configuration the first CO2 removal assembly is positioned outside of the duct while the second CO2 removal assembly is positioned inside of the duct in the adsorption configuration, and wherein in the desorption configuration the second CO2 removal assembly is positioned outside of the duct while the first CO2 removal assembly is positioned inside of the duct in the adsorption configuration.

Another example can include any of the above and/or below examples where in the desorption configuration the first CO2 removal assembly is positioned inside of the duct and occupies a minority of a cross-sectional area of the duct while the second CO2 removal assembly is in the adsorption configuration and occupies a majority of the cross-sectional area of the duct, and wherein in the desorption configuration the second CO2 removal assembly is positioned inside of the duct and occupies a minority of the cross-sectional area of the duct while the first CO2 removal assembly is in the adsorption configuration and occupies a majority of the cross-sectional area of the duct.

Another example can include any of the above and/or below examples where the air flows along a long axis of the duct and the duct has a cross-sectional area measured transverse to the long axis and wherein the first CO2 removal assembly and the second CO2 removal assembly collectively cover all of the cross-sectional area of the duct.

Another example can include any of the above and/or below examples where the first CO2 removal assembly covers 50% of the cross-sectional area of the duct and the second CO2 removal assembly covers a different 50% of the cross-sectional area of the duct.

Another example can include any of the above and/or below examples where the system further comprises an air deflector that is controlled by the controller to block airflow to either of the first CO2 removal assembly or the second CO2 removal assembly that is in the desorption configuration.

Another example can include any of the above and/or below examples where the air deflector is moveable by the controller to cover either of the first CO2 removal assembly or the second CO2 removal assembly that is in the desorption configuration and to uncover the other of the first CO2 removal assembly or the second CO2 removal assembly that is in the adsorption configuration.

Another example can include any of the above and/or below examples where the air deflector covers both of the first CO2 removal assembly and the second CO2 removal assembly, and wherein a first portion of the air deflector that covers the first CO2 removal assembly is independently controllable by the controller from a second portion of the air deflector that covers the second CO2 removal assembly.

Another example can include any of the above and/or below examples where the first CO2 removal assembly comprises multiple adsorbent beds.

Another example can include any of the above and/or below examples where the multiple adsorbent beds are planar.

Another example can include any of the above and/or below examples where the multiple adsorbent planar beds include support pins that extend through individual adsorbent planar beds perpendicular to a plane of the individual adsorbent planar beds.

Another example can include any of the above and/or below examples where the multiple adsorbent planar beds are coupled in an accordion-like manner, and wherein the multiple adsorbent planar beds are parallel to one another in the desorption configuration and the multiple adsorbent planar beds are at acute angles relative to one another in the adsorption configuration.

Another example can include any of the above and/or below examples where the pins of adjacent adsorbent planar beds align to contact one another when the multiple adsorbent planar beds are parallel to one another in the desorption configuration.

Another example can include any of the above and/or below examples where the multiple adsorbent planar beds are parallel to one another in both the desorption configuration and the adsorption configuration, and the multiple adsorbent planar beds are positioned relatively closer to one another in the desorption configuration than in the adsorption configuration.

Another example can include any of the above and/or below examples where the first CO2 removal assembly comprises a sinusoidal adsorbent bed that has a longer curve in the adsorption configuration and a shorter curve in the desorption configuration.

Another example can include any of the above and/or below examples where the system further comprises at least a third CO2 removal assembly that is operated by the controller in cooperation with the first CO2 removal assembly and the second CO2 removal assembly so that at least one of the first CO2 removal assembly, the second CO2 removal assembly, and the third CO2 removal assembly is always operating in the adsorption configuration.

Another example includes a system comprising a duct extending from an external environment to an internal environment, a fan configured to move air through the duct, and first and second CO2 removal assemblies configured to alternatively transition between CO2 adsorption mode and CO2 desorption mode so that one of either the first and second CO2 removal assemblies is in CO2 adsorption mode and receiving at least some of the air moving through the duct while the other of the first and second CO2 removal assemblies is not receiving air moving through the duct while CO2 is removed in desorption mode.

Another example includes a CO2 removal assembly comprising a regeneration chamber including a vacuum port and multiple CO2 adsorbent beds positioned in the regeneration chamber, individual CO2 adsorbent beds defining first and second spaced-apart major surfaces and having anti-compression pins extending between the first and second spaced-apart major surfaces, the multiple CO2 adsorbent beds secured together in an accordion-like manner and forming acute angles therebetween in a CO2 adsorption configuration and are parallel to and against one another in a CO2 desorption configuration where the anti-compression pins of adjacent CO2 adsorbent beds contact one another and resist compression by a vacuum applied to the vacuum port of the regeneration chamber.

Although techniques, methods, devices, systems, etc., pertaining to CO2 removal are described in language specific to structural features and/or methodological acts, it is to be understood that the subject matter defined in the appended claims is not limited to the specific features or acts described. Rather, the specific features and acts are disclosed as example forms of implementing the claimed methods, devices, systems, etc.

1. A system, comprising:
a duct extending from a first environment to a second environment;
a fan configured to move air through the duct;
a first CO2 removal assembly having a CO2 adsorption configuration and a CO2 desorption configuration;
a second CO2 removal assembly having a CO2 adsorption configuration and a CO2 desorption configuration; and,
a controller configured to operate the first CO2 removal assembly in the adsorption configuration to receive at least some of the air moving through the duct and the second CO2 removal assembly in the desorption configuration that does not receive air moving through the duct while CO2 is removed and then to operate the first CO2 removal assembly in the desorption configuration that does not receive air moving through the duct while CO2 is removed and the second CO2 removal assembly in the adsorption configuration to receive at least some of the air moving through the duct.

2. The system of claim 1, wherein the air flows along a long axis of the duct and the duct has a cross-sectional area measured transverse to the long axis, and wherein in the CO2 adsorption configuration the first CO2 removal assembly covers all of the cross-sectional area, and wherein in the CO2 adsorption configuration the second CO2 removal assembly covers all of the cross-sectional area.

3. The system of claim 2, wherein the first CO2 removal assembly and the second CO2 removal assembly are positioned in series along the long axis.

4. The system of claim 3, wherein in the desorption configuration the first CO2 removal assembly is positioned outside of the duct while the second CO2 removal assembly is positioned inside of the duct in the adsorption configuration, and wherein in the desorption configuration the second CO2 removal assembly is positioned outside of the duct while the first CO2 removal assembly is positioned inside of the duct in the adsorption configuration.

5. The system of claim 1, wherein in the desorption configuration the first CO2 removal assembly is positioned inside of the duct and occupies a minority of a cross-sectional area of the duct while the second CO2 removal assembly is in the adsorption configuration and occupies a majority of the cross-sectional area of the duct, and wherein in the desorption configuration the second CO2 removal assembly is positioned inside of the duct and occupies a minority of the cross-sectional area of the duct while the first CO2 removal assembly is in the adsorption configuration and occupies a majority of the cross-sectional area of the duct.

6. The system of claim 1, wherein the air flows along a long axis of the duct and the duct has a cross-sectional area measured transverse to the long axis and wherein the first CO2 removal assembly and the second CO2 removal assembly collectively cover all of the cross-sectional area of the duct.

7. The system of claim 6, wherein the first CO2 removal assembly covers 50% of the cross-sectional area of the duct and the second CO2 removal assembly covers a different 50% of the cross-sectional area of the duct.

8. The system of claim 7, further comprising an air deflector that is controlled by the controller to block airflow to either of the first CO2 removal assembly or the second CO2 removal assembly that is in the desorption configuration.

9. The system of claim 8, wherein the air deflector is moveable by the controller to cover either of the first CO2 removal assembly or the second CO2 removal assembly that is in the desorption configuration and to uncover the other of the first CO2 removal assembly or the second CO2 removal assembly that is in the adsorption configuration.

10. The system of claim 9, wherein the air deflector covers both of the first CO2 removal assembly and the second CO2 removal assembly, and wherein a first portion of the air deflector that covers the first CO2 removal assembly is independently controllable by the controller from a second portion of the air deflector that covers the second CO2 removal assembly.

11. The system of claim 1, wherein the first CO2 removal assembly comprises multiple adsorbent beds.

12. The system of claim 11, wherein the multiple adsorbent beds are planar.

13. The system of claim 12, wherein the multiple adsorbent planar beds include support pins that extend through individual adsorbent planar beds perpendicular to a plane of the individual adsorbent planar beds.

14. The system of claim 13, wherein the multiple adsorbent planar beds are coupled in an accordion-like manner, and wherein the multiple adsorbent planar beds are parallel to one another in the desorption configuration and the multiple adsorbent planar beds are at acute angles relative to one another in the adsorption configuration.

15. The system of claim 14, wherein the pins of adjacent adsorbent planar beds align to contact one another when the multiple adsorbent planar beds are parallel to one another in the desorption configuration.

16. The system of claim 13, wherein the multiple adsorbent planar beds are parallel to one another in both the desorption configuration and the adsorption configuration, and the multiple adsorbent planar beds are positioned relatively closer to one another in the desorption configuration than in the adsorption configuration.

17. The system of claim 1, wherein the first CO2 removal assembly comprises a sinusoidal adsorbent bed that has a longer curve in the adsorption configuration and a shorter curve in the desorption configuration.

18. The system of claim 1, further comprising at least a third CO2 removal assembly that is operated by the controller in cooperation with the first CO2 removal assembly and the second CO2 removal assembly so that at least one of the first CO2 removal assembly, the second CO2 removal assembly, and the third CO2 removal assembly is always operating in the adsorption configuration.

19. A system, comprising:
a duct extending from an external environment to an internal environment;
a fan configured to move air through the duct; and,
first and second CO2 removal assemblies configured to alternatively transition between CO2 adsorption mode and CO2 desorption mode so that one of either the first and second CO2 removal assemblies is in CO2 adsorption mode and receiving at least some of the air moving through the duct while the other of the first and second CO2 removal assemblies is not receiving air moving through the duct while CO2 is removed in desorption mode.

20. A CO2 removal assembly, comprising:
a regeneration chamber including a vacuum port; and,
multiple CO2 adsorbent beds positioned in the regeneration chamber, individual CO2 adsorbent beds defining first and second spaced-apart major surfaces and having anti-compression pins extending between the first and second spaced-apart major surfaces, the multiple CO2 adsorbent beds secured together in an accordion-like manner and forming acute angles therebetween in a CO2 adsorption configuration and are parallel to and against one another in a CO2 desorption configuration where the anti-compression pins of adjacent CO2 adsorbent beds contact one another and resist compression by a vacuum applied to the vacuum port of the regeneration chamber.
